(19) United States
(12) Patent Application Publication
(10) Pub. No.: US 2016/0128451 A1
(43) Pub. Date: May 12, 2016

(54) HAIR CUTTER

(71) Applicant: Young Jin LEE, Ulsan (KR)

(72) Inventor: Young Jin LEE, Ulsan (KR)

(21) Appl. No.: 14/893,967

(22) PCT Filed: May 29, 2014
(86) PCT No.: PCT/KR2014/004818

§ 371 Date: Nov. 25, 2015

(30) Foreign Application Priority Data
Jul. 26, 2013 (KR) 10-2013-0089149

(51) Int. Cl. A45D 44/02; F16M 11/22

(52) U.S. Cl. CPC A45D 44/02; F16M 11/22

(57) ABSTRACT

The present invention provides a hair cutter, which comprises: supports; horizontal stages; and an upper stage, which are fastened and fixed to one another. According to the hair cutter of the present invention, a user can operate a cut operation by spreading and fanning out all of the hair so that the user can operate a cut design as planned using a hair pincette member. Thus, not one part of, but the whole spread diagram can be expressed at once with real hair, and even a user with little experience can complete the style as designed in the spread diagram without a mistake if the user completes the configuration in accordance with the spread diagram and then cuts the hair.

### TECHNICAL FIELD

The present invention relates to a hair cutter. More particularly, the present invention relates to a hair cutter that is configured to perform a cutting procedure with all of the hair being fanned out and spread, thus allowing a user to perform the cutting procedure as planned in a hair shop or a hairdressing school.

### BACKGROUND ART

Generally, when a cutting procedure is performed for a customer in a hair shop or a cutting practice is performed for a model, a mannequin or the like in a hairdressing educational institution, a hair dresser designs a hairstyle, largely parts hair locks from the head or divides hair into several small sections, and then fixes them using a hair fixing pincette. Subsequently, while the hair dresser holds the hair lock with one hand, he or she cuts the hair with the other hand using scissors. Thereafter, the cutting procedure is performed in the same manner using a cut hair portion as a guide.

FIG. 1 is a view illustrating a general process of cutting a customer's hair in a hair shop, and FIG. 2 is a view illustrating a real person or a mannequin that is generally used in teaching a hair-cutting process to trainees in a hairdressing school. As shown in FIG. 1, a hairdresser performs a cutting procedure while imagining an imaginary design line for cutting the hair. Further, as shown in FIG. 2, when a teacher gives trainees a hair cutting lesson in a hairdressing educational institution, he or she usually performs the hair cutting procedure while explaining the imaginary design line that is actually invisible. Although there exists a head point that is commonly fixed in the cutting procedure, people have different head shapes and hair textures, and thereby a hairdresser should perform a cutting procedure while always carefully recognizing his or her posture and position as well as a customer's posture and position. In this regard, unless the hairdresser precisely recognizes the posture and position, a cutting result may be unsatisfactory. Since an angle recognizing capability and design understanding vary from person to person, it is difficult to teach the same standard of cutting technique to students and intern hairdressers. Further, in order to overcome the problem, students and interns may practice a cutting procedure on a mannequin or a model. However, even in this case, it is impossible to restore the cut hair to its original state. Thus, a difference between an originally imagined design and a completed design may result.

Currently, in the hair cutting procedure or lesson, it is impossible to previously confirm a whole design, and each person merely expects the design. Since people have only two hands, it is impossible to hold tens of spread diagrams at once. Particularly, if the hand is released from the hair after it has been cut, the hair is moved downwards due to gravity and the spread diagrams cannot be seen. Therefore, it is impossible to maintain all of the spread diagrams, and a hairdresser merely expects a design in his or her mind. Further, it is difficult to reproduce about 150,000 strands of hair in a design having the same length and angle, in terms of time and procedure.

### DISCLOSURE

### Technical Problem

Accordingly, the present invention has been made keeping in mind the above problems occurring in the related art, and is intended to provide a hair cutter, in which supports, horizontal stages, and an upper stage are fastened and fixed to one another and hair pincette members are used, and which is configured to perform a cutting procedure with all of the hair being fanned out and spread, thus allowing a user to perform the cutting procedure as planned. Therefore, not a part but a whole of the spread diagram can be expressed at once for real hair, and even a user with little experience can complete the style as designed in the spread diagram without a mistake if the user completes the configuration in accordance with the spread diagram and then cuts hair.

Another object of the present invention is to provide a hair cutter, in which, if a hairdressing procedure or lesson is performed in horizontal stages having different heights and hair pincette members, it is possible to improve the acquisition of the height and position of each horizontal stage, the position, height and angle of a customer or a mannequin, and the position, height and angle of a user himself or herself, and which is intended to allow a part or a whole of a sectional spread diagram that was conventionally checked only by a diagram to be checked by visual observation.

A further object of the present invention is to provide a hair cutter, which solves a problem wherein it is impossible to restore the hair that has been cut to its original state in a hair cutting lesson, by completing an ideal cutting operation after infinitely changing a spread diagram, thus reducing the waste of a training mannequin due to wrong cutting, and which allows a user to rapidly and precisely determine the angle, direction and length of the hair during a hair cutting operation without the necessity of installing the hair cutter after the acquisition, thus enhancing educational effects.

### Technical Solution

In an aspect, the present invention provides a hair cutter including at least one support vertically erected in a cutting space where a customer or a model sits; at least one horizontal stage fixedly installed at the support; and an upper stage fixedly installed at a position above an upper end of the support to fix a top layer of hair of the customer or the model vertically or upwards.

Preferably, the at least horizontal stage may be formed in a shape of a circular ring and be integrally fixed to the at least one support.

Preferably, the at least horizontal stage may be formed in a shape of a circular ring and be fastened to a locking hook provided on the at least one support in such a way as to be removably secured thereto.

Preferably, the at least horizontal stage may be formed in a shape of a circular ring and be installed at each of a position of the upper end corresponding to a top of the head of the customer or the model, a position of a middle end corresponding to the head of the customer or the model, and a position of a lower end corresponding to a chair's seat in which the customer or the model sits.

Preferably, the upper stage may include either of a straight-shaped fixing bar or a cross-shaped fixing bar.

Preferably, the upper stage may include a straight-shaped fixing bar or a cross-shaped fixing bar, and a plurality of circular rings that may be connected to the fixing bar and be different in diameter from each other.

Preferably, the hair cutter may further include a hair pincette member connected at a first side thereof to the hair of the customer or the model, and connected at a second side thereof to the at least one horizontal stage or the upper stage, and the hair pincette member may include a pincette for holding or releasing the hair of the customer or the model, a string connected at a first end thereof to the pincette, and a connector connected to a second end of the string, the connector being connected to the horizontal stage or the upper stage.

More preferably, the hair pincette member may have any one structure selected from a structure where the connector provided on the second end of the string connected to the pincette may include a roll structure around which the string may be wound and a fixing member or a hook which may be fixedly mounted to each stage, a structure where the connector provided on the second end of the string connected to the pincette may comprise a magnet, a structure where the connector provided on the second end of the string connected to the pincette may comprise a pin, and a structure where the connector provided on the second end of the string connected to the pincette may comprise a hook shape.

### Advantageous Effects

As described above, the hair cutter according to the present invention is advantageous in that supports, horizontal stages, and an upper stage are fastened and fixed to one another and hair pincette members are used, and the hair cutter is configured to perform a cutting procedure with all of the hair being fanned out and spread, thus allowing a user to perform the cutting procedure as planned. Therefore, not a part but a whole of the spread diagram can be expressed at once for real hair, and even a user with little experience can complete the style as designed in the spread diagram without a mistake if the user completes the configuration in accordance with the spread diagram and then cuts hair.

Further, the hair cutter according to the present invention is advantageous in that, if a hairdressing procedure or lesson is performed in horizontal stages having different heights and hair pincette members, it is possible to improve the acquisition of the height and position of each horizontal stage, the position, height and angle of a customer or a mannequin, and the position, height and angle of a user himself or herself, and the hair cutter is intended to allow a part or a whole of a sectional spread diagram that was conventionally checked only by a diagram to be checked by visual observation.

Furthermore, the hair cutter according to the present invention is advantageous in that it solves a problem wherein it is impossible to restore the hair that has been cut to its original state in a hair cutting lesson, by completing an ideal cutting operation after infinitely changing a spread diagram, thus reducing the waste of a training mannequin due to wrong cutting, and it allows a user to rapidly and precisely determine the angle, direction and length of the hair during a hair cutting operation without the necessity of installing the hair cutter after the acquisition, thus enhancing educational effects.

### DESCRIPTION OF DRAWINGS

FIG. 1 is a view illustrating a general process of cutting a customer's hair in a hair shop;

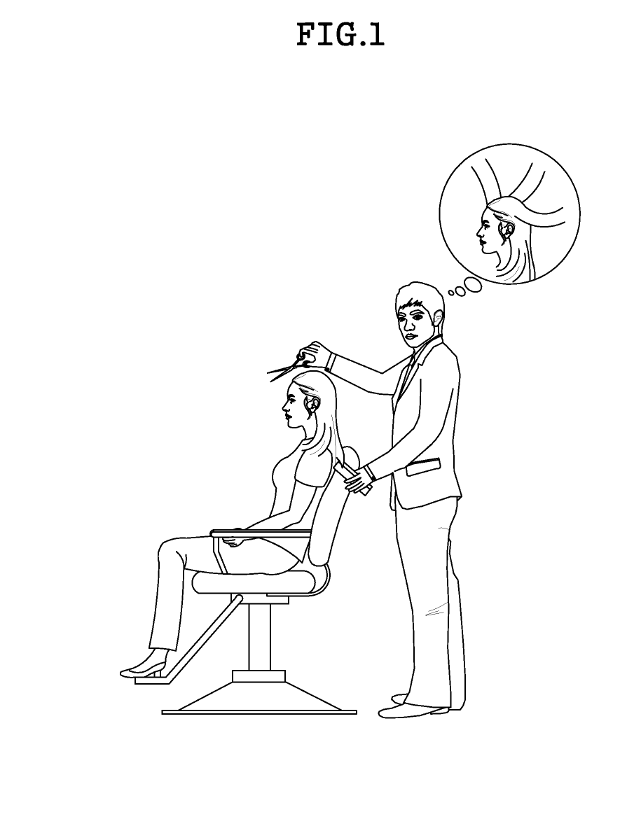

FIG. 2 is a view illustrating a real person or a mannequin that is generally used in teaching a hair-cutting process to trainees in a hairdressing school;

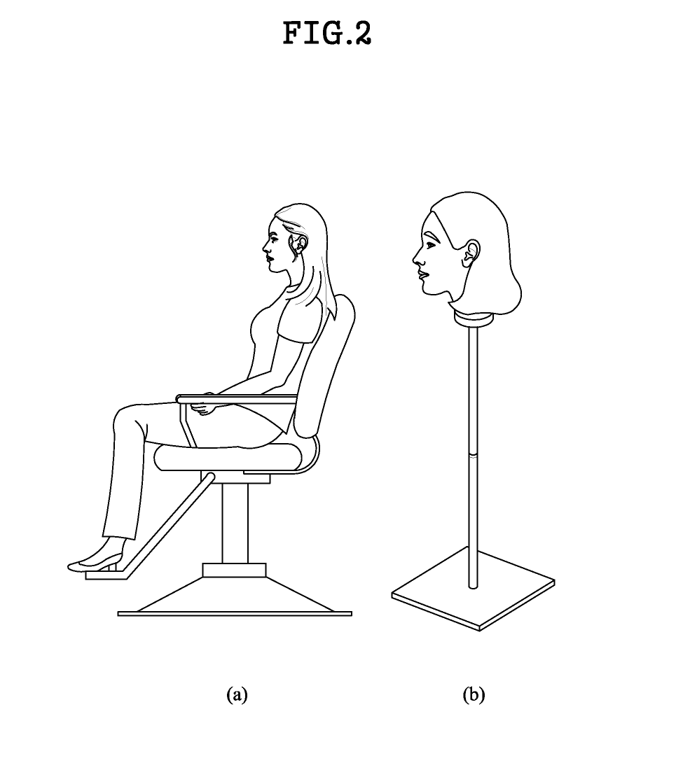

FIG. 3 is a view illustrating the configuration of a hair cutter according to an embodiment of the present invention;

FIG. 4 is a view illustrating the configuration of a hair pincette member used in the hair cutter according to the embodiment of the present invention;

FIG. 5 is a view illustrating the configuration of an example where the hair cutter according to the embodiment of the present invention is applied to a customer or a model in a hair shop; and

FIG. 6 is a view illustrating the configuration of an example where the hair cutter according to the embodiment of the present invention is applied to a mannequin model.

*Description of reference numerals of important parts*

| | |
|---|---|
| 10: support | 111: upper end |
| 112: middle end | 113: lower end |
| 114: locking hook | 120: horizontal stage |
| 130: upper stage | 140: hair pincette member |
| 141: pincette | 142: string |
| 143: connector | 143a: roll structure |
| 143b: hook | 143c: magnet |
| 143d: pin | 143e: hook shape |
| 143f: fixing member | |

### BEST MODE

Hereinafter, a preferred embodiment will be described in detail with reference to the accompanying drawings so that those skilled in the art can easily carry out the present invention. In the following description, if it is decided that the detailed description of known function or configuration related to the invention makes the subject matter of the invention unclear, the detailed description is omitted. The same reference numerals refer to the same components throughout the specification.

In addition, when the term “connect” is used in the following description, it is intended to mean not only “directly connected to” but also “indirectly connected to” such as connected through another intervening element. Further, the expression of “including a component” is intended to mean that another component is not excluded but is further included unless otherwise specified.

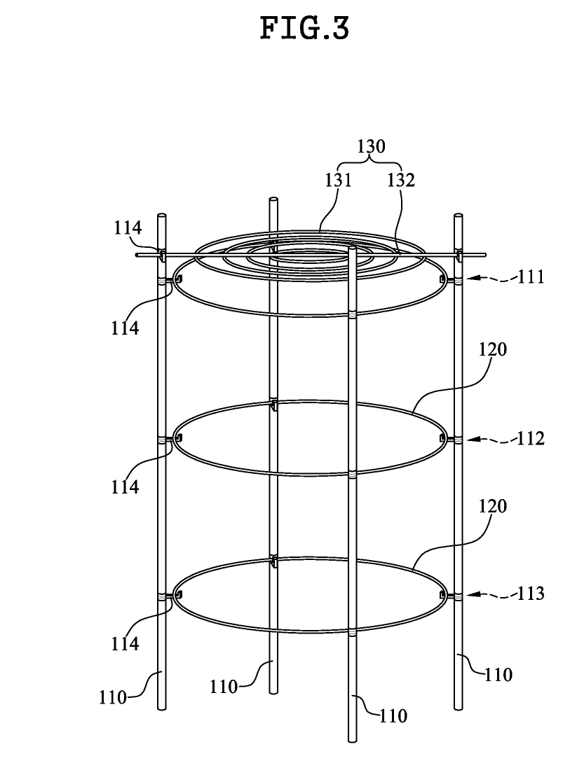

FIG. 3 is a view illustrating the configuration of a hair cutter according to an embodiment of the present invention, and

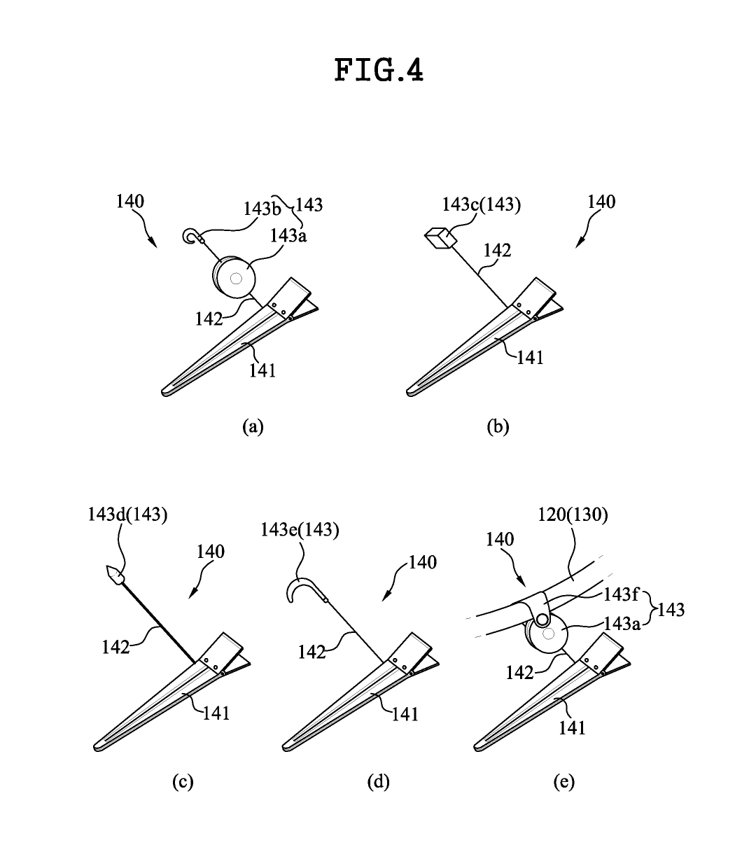

FIG. 4 is a view illustrating the configuration of a hair pincette member used in the hair cutter according to the embodiment of the present invention. As shown in FIG. 3, the hair cutter according to the embodiment of the present invention may include supports 110, horizontal stages 120 and an upper stage 130. As shown in FIG. 4, the hair cutter may further include a hair pincette member 140.

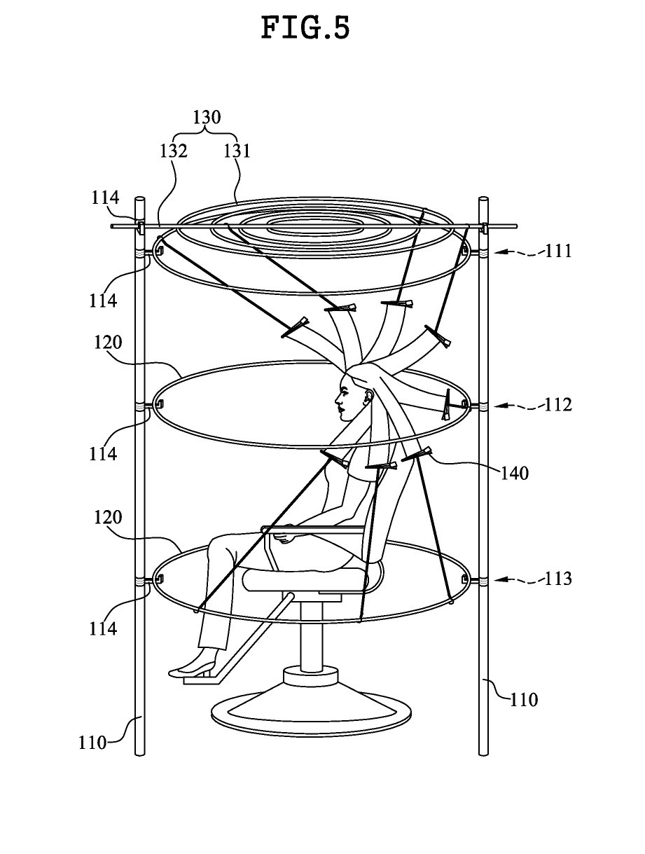

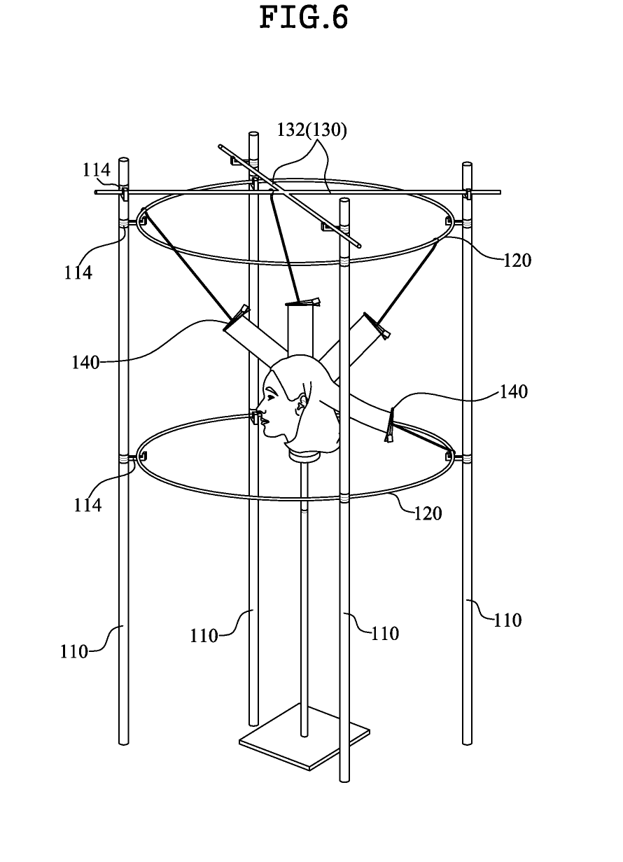

Each support 110 comprises one or more rods that are vertically set up in a cutting space where a customer or a model sits. Such a support 110 may be divided into an upper end 111, a middle end 112 and a lower end 113 at which one or more horizontal stages 120 that will be described later are to be installed. The upper stage 130 may be locked to or unlocked from a locking hook 114 located at a position above the upper end 111. Further, the locking hook 114 may be further formed on each of the upper end 111, the middle end 112 and the lower end 113, which are positions at which the horizontal stages 120 are fixedly installed, thus allowing each horizontal stage 120 to be removably fastened thereto. Here, the locking hook 114 may be eliminated if the upper stage 130 and the horizontal stage 120 are integrated with each other by welding or the like. Further, as shown in FIGS. 3 and 6, four supports 110 may be provided to maintain balance. Further, as shown in FIG. 5, only two supports 110 may be provided. In this case, since it is difficult to maintain balance using only the two supports 110, a bottom support (not shown) may be further provided on a bottom of the support 110. Meanwhile, the support 110 is generally erected and fixed on the ground, but the invention is not limited thereto. By way of example, the support 110 may hang from a ceiling in such a way as to float in the air, or an upper portion of the support 110 may be attached to a wall. Indeed, when the support 110 is fixed to the ceiling or is fixedly connected to the upper portion of a rod, the center of gravity is significant due to a height. In addition, even if the support is secured to an upper position, balance is well maintained due to the weight and thus installation and use thereof are easy.

The horizontal stage 120 has the shape of a circular ring that is secured to the support 110. One or more horizontal stages 120 may be further provided and integrally secured to one or more supports 110. In this regard, the horizontal stage 120 may be integrally secured by welding or the like. Further, one or more horizontal stages 120 may have the shape of the circular ring, but may be fastened to the locking hook 114 formed on each of the supports 110 to be removably attached thereto. That is, one or more horizontal stages 120 have the shape of the circular ring, and are integrally or removably installed at one of a position of the upper end 111 of the support 110 corresponding to the top of the head of a customer or a model, a position of the middle end 112 of the support 110 corresponding to the head of a customer or a model, and a position of the lower end 113 of the support 110 corresponding to a chair's seat in which a customer or a model sits.

The upper stage 130 may be installed at a position above the upper end 111 of the support 110 to fix a top layer of hair of a customer or a model vertically or upwards. Such an upper stage 130 may include either of a straight-shaped fixing bar 132 or a cross-shaped fixing bar 132. Further, the upper stage 130 may include a straight-shaped fixing bar 132 or a cross-shaped fixing bar 132, and a plurality of circular rings 131 that are connected to the straight-shaped or cross-shaped fixing bar 132 and are different in diameter from each other.

The hair pincette member 140 is configured such that one side thereof is connected to the hair of a customer or model, and the other side is connected to one or more horizontal stages 120 or the upper stage 130. Such a hair pincette member 140 includes a pincette 141 for holding or releasing the hair of a customer or model, a string 142 connected at one end thereof to the pincette 141, and a connector 143 connected to the other end of the string 142. Here, the connector 143 is connected to the horizontal stage 120 or the upper stage 130 when in use. In particular, as shown in FIG. 4a, the hair pincette member 140 may be configured such that the connector 143 provided on the other end of the string 142 connected to the pincette 141 includes a roll structure 143a around which the string 142 is wound and a hook 143b provided on the roll structure. Further, as shown in FIG. 4b, the hair pincette member 140 may be configured such that the connector 143 provided on the other end of the string 142 connected to the pincette 141 comprises a magnet 143c. Furthermore, as shown in FIG. 4c, the hair pincette member 140 may be configured such that the connector 143 provided on the other end of the string 142 connected to the pincette 141 comprises a pin 143d. Further, as shown in FIG. 4d, the hair pincette member 140 may be configured such that the connector 143 provided on the other end of the string 142 connected to the pincette 141 comprises a hook shape 143e. Further, as shown in FIG. 4e, the hair pincette member 140 may be configured such that the connector 143 provided on the other end of the string 142 connected to the pincette 141 includes a roll structure 143a around which the string 142 is wound and a fixing member 143f that is fixedly mounted to each stage 120, 130. Preferably, the string 142 constituting the hair pincette member 140 is made of an elastic material.

FIG. 5 is a view illustrating the configuration of an example where the hair cutter according to the embodiment of the present invention is applied to a customer or a model in a hair shop, and FIG. 6 is a view illustrating the configuration of an example where the hair cutter according to the embodiment of the present invention is applied to a mannequin model. As shown in FIGS. 5 and 6, the hair cutter according to the embodiment of the present invention is installed as follows: one or more horizontal stages 120 and the upper stage 130 are installed, respectively, at predetermined heights and positions on one or more supports 110, and then a person or a mannequin is located in the hair cutter. Thereafter, a hair dresser divides the hair as designed in the spread diagram to set the length, angle and direction of the hair, and fixes the hair using the hair pincette member 140. Subsequently, the connector 143 of the hair pincette member 140 catching the hair is connected to a predetermined position of each of the horizontal stages 120 and the upper stage 130, thus maintaining a length and a tensile force between the pincette 141 and the stage. Continuously, the overall style of hair is completed as designed in the spread diagram in the above-mentioned method. If a user desires to make a new design regardless of the spread diagram, various designs are created regardless of marks on each of the horizontal stages 120 and the upper stage 130. Thereafter, a hair dresser completes a cutting procedure using various cutting tools such as scissors, a razor blade or a trimmer.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A hair cutter comprising:
at least one support (110) vertically erected in a cutting space where a customer or a model sits;
at least one horizontal stage (120) fixedly installed at the support (110); and
an upper stage (130) fixedly installed at a position above an upper end (111) of the support (110) to fix a top layer of hair of the customer or the model vertically or upwards.

2. The hair cutter according to claim 1, wherein the at least horizontal stage (120) is formed in a shape of a circular ring, and is integrally fixed to the at least one support (110).

3. The hair cutter according to claim 1, wherein the at least horizontal stage (120) is formed in a shape of a circular ring, and is fastened to a locking hook (114) provided on the at least one support (110) in such a way as to be removably secured thereto.

4. The hair cutter according to claim 1, wherein the at least horizontal stage (120) is formed in a shape of a circular ring, and is installed at each of a position of the upper end (111) corresponding to a top of the head of the customer or the model, a position of a middle end (112) corresponding to the head of the customer or the model, and a position of a lower end (113) corresponding to a chair's seat in which the customer or the model sits.

5. The hair cutter according to claim 1, wherein the upper stage (130) comprises either of a straight-shaped fixing bar (132) or a cross-shaped fixing bar (132).

6. The hair cutter according to claim 1, wherein the upper stage (130) comprises a straight-shaped fixing bar (132) or a cross-shaped fixing bar (132), and a plurality of circular rings (131) that are connected to the fixing bar (132) and are different in diameter from each other.

7. The hair cutter according to claim 1, further comprising:
a hair pincette member (140) connected at a first side thereof to the hair of the customer or the model, and connected at a second side thereof to the at least one horizontal stage (120) or the upper stage (130),
wherein the hair pincette member (140) comprises a pincette (141) for holding or releasing the hair of the customer or the model, a string (142) connected at a first end thereof to the pincette (141), and a connector (143) connected to a second end of the string (142), the connector (143) being connected to the horizontal stage (120) or the upper stage (130).

8. The hair cutter according to claim 7, wherein the hair pincette member (140) has a structure selected from the group consisting of a structure where the connector (143) provided on the second end of the string (142) connected to the pincette (141) includes a roll structure (143a) around which the string (142) is wound and a fixing member (1430 which is fixedly mounted to each stage, a structure where the connector (143) provided on the second end of the string (142) connected to the pincette (141) includes a roll structure (143a) around which the string (142) is wound and a hook (143b) connected to the roll structure, a structure where the connector (143) provided on the second end of the string (142) connected to the pincette (141) comprises a magnet (143c), a structure where the connector (143) provided on the second end of the string (142) connected to the pincette (141) comprises a pin (143d), and a structure where the connector (143) provided on the second end of the string (142) connected to the pincette (141) comprises a hook shape (143e).
